(19) United States
(12) Patent Application Publication
(10) Pub. No.: US 2026/0365189 A1
(43) Pub. Date: Nov. 19, 2026

(54) ELECTRIC DRIVE SYSTEM COUPLED TO A FRONT DIFFERENTIAL OF AN INTERNAL COMBUSTION VEHICLE.

(71) Applicants: Rustee Stubbs, Washington, UT (US); Kenneth Miller, Williston, ND (US)

(72) Inventors: Rustee Stubbs, Washington, UT (US); Kenneth Miller, Williston, ND (US)

(21) Appl. No.: 19/681,304

(22) Filed: May 19, 2026

Related U.S. Application Data
(60) Provisional application No. 63/808,387, filed on May 19, 2025.

(51) Int. Cl. B60W 50/029; B60W 10/08; B60W 10/26; B60W 20/13; B60W 20/50; B60W 30/02; B60W 30/18; B60W 30/182; B60W 30/188

(52) U.S. Cl. CPC B60W 50/029; B60W 10/08; B60W 10/26; B60W 20/13; B60W 20/50; B60W 30/02; B60W 30/18127; B60W 30/182; B60W 30/188; B60W 2510/244; B60W 2710/083

(57) ABSTRACT

A hybrid vehicle system for a vehicle having an internal combustion engine includes a transfer case having a first output associated with a rear driveline, a second output associated with a front driveline, and a third output associated with an electric motor. The electric motor is coupled to the transfer case such that the electric motor selectively operates in a generator mode and a propulsion mode. When rotational energy is received through the transfer case during operation of the internal combustion engine, the electric motor may operate in the generator mode to charge one or more batteries. When the one or more batteries satisfy a selected state-of-charge condition, the electric motor may operate in the propulsion mode to transmit torque through the transfer case to a selected driveline output, including a front differential, thereby providing electric propulsion or supplemental torque assist.

### CROSS-REFERENCE TO RELATED APPLICATIONS

This application claims the benefit of U.S. Provisional App. Ser. No. 63/808,387 filed on May 19, 2025, which is incorporated herein by reference.

### TECHNICAL FIELD

The present disclosure relates to hybrid vehicles. More particularly, the present disclosure relates to an electric drive system configured to control and assist the operation of an internal combustion engine and associated vehicle.

### BACKGROUND

Internal combustion engine (ICE) vehicles continue to be widely used in passenger vehicles, trucks, sport utility vehicles, and other on-road and off-road platforms because of existing fueling infrastructure, established driveline architectures, and operating range that may be desirable in many applications. However, conventional ICE-powered vehicles may exhibit reduced overall efficiency in certain operating conditions, such as stop-and-go driving, low-speed maneuvering, idling, grade changes, and other transient load conditions. In addition, operation of an ICE as the sole propulsion source may increase fuel consumption and associated emissions relative to driveline arrangements that selectively supplement engine output with electric power.

Various hybrid vehicle arrangements have been proposed to improve efficiency by combining an ICE with one or more electric machines and an energy storage system. Such arrangements may provide regenerative braking, engine stop/start capability, and torque assist under selected operating conditions. Nevertheless, many hybrid architectures are integrated at the transmission, axle, or dedicated e-drive level in ways that may increase packaging complexity, require substantial redesign of existing vehicle driveline components, or be less suitable for implementation in vehicles originally configured as ICE vehicles. In certain vehicle platforms, and particularly in four-wheel-drive or all-wheel-drive platforms employing a transfer case and separate front and rear driveline outputs, available space, alignment constraints, thermal management, and control integration may complicate incorporation of an electric assist system.

Accordingly, a need exists for systems and methods that can selectively recover mechanical energy from an operating ICE drivetrain, charge one or more batteries without relying exclusively on regenerative braking, and further use stored electrical energy to supplement or temporarily replace ICE-provided propulsion under suitable operating conditions. A further need exists for an electric drive arrangement that may be coupled to a transfer case, differential output, or related driveline component so that electric assist and generator functionality can be provided in a compact manner that is adaptable to existing vehicle architectures, including vehicles having front and rear differentials. The present disclosure addresses these and other needs.

### SUMMARY OF EXAMPLE EMBODIMENTS

In some embodiments, a hybrid vehicle system comprises an internal combustion engine (ICE), a transmission driveline, a transfer case, at least a front differential, an electric motor, one or more batteries, and a controller such as an electronic control module or electronic control unit (ECM/U). The electric motor may be coupled to the transfer case directly or indirectly, such as through an intermediate shaft, geartrain, gearbox, reduction assembly, coupling, chain drive, belt drive, or other torque-transmitting arrangement. In some embodiments, the electric motor is selectively operable in a motor mode to provide propulsion torque to a vehicle driveline and in a generator mode to convert mechanical energy from the driveline into electrical energy for storage in the one or more batteries.

In some embodiments, the transfer case comprises a first output associated with a rear driveline, a second output associated with a front driveline, and a third output or output associated with the electric motor. The electric motor may thereby remain in constant driving communication with the transfer case, or may be selectively coupled thereto by one or more clutches, couplers, disconnects, or engagement mechanisms. In certain implementations, the electric motor is coupled so as to drive a front differential through the transfer case, although embodiments are also contemplated in which torque is delivered to a rear differential or to both front and rear driveline components depending on the configuration of the transfer case and associated driveline members.

In some embodiments, when the ICE is operating and the driveline is rotating, the transfer case may transmit mechanical energy to the electric motor such that the electric motor operates as a generator to charge the one or more batteries. In some embodiments, when the one or more batteries have a predetermined or sufficient state of charge, the electric motor may be configured to operate in a traction-assist or electric-propulsion mode so that torque from the electric motor is transmitted through the transfer case to a selected differential and then to one or more wheels. Such operation may supplement ICE torque, reduce load on the ICE, support low-speed operation, or in some circumstances propel the vehicle with the ICE off.

In some embodiments, the controller is configured to monitor one or more vehicle operating conditions and to command operation of the ICE, the electric motor, and one or more driveline coupling devices based on those conditions. The monitored conditions may include, by way of example, driver torque request, vehicle speed, wheel speed, battery state of charge, battery temperature, motor temperature, coolant temperature, transmission state, transfer case state, brake application, accelerator position, clutch position, fault conditions, and traction-related signals. In vehicles having a manual transmission, the controller may further coordinate clutch engagement or disengagement. In vehicles having an automatic transmission, the controller may further coordinate torque converter operation, gear selection, or both.

In some embodiments, the controller executes a control routine in which vehicle status information is read, evaluated, and compared against one or more thresholds or decision criteria. If a requested torque level exceeds a selected threshold, the controller may command operation of the ICE and may further command the electric motor to provide supplemental positive torque when battery conditions permit. If the requested torque level is below a selected threshold, the controller may command reduced ICE operation or engine shutdown and may cause the electric motor to propel the vehicle. If battery state of charge falls below a selected level, the controller may command generator operation of the electric motor so that negative torque is applied through the transfer case to recover energy and recharge the one or more batteries.

In some embodiments, during deceleration, low torque request, or brake application, the electric motor may apply a negative torque to the transfer case and associated driveline so that the electric motor functions as a generator while vehicle speed is reduced. Regenerative operation may occur alone or together with foundation braking and may be limited, reduced, or disabled based on battery state of charge, temperature, vehicle stability conditions, anti-lock braking system inputs, driveline protection limits, or other safety-related constraints. Numerical threshold values described herein are illustrative only, and other thresholds, ranges, decision maps, or adaptive control strategies may be used.

In some embodiments, the hybrid vehicle system further comprises a motor controller or inverter, a cooling system for the electric motor and associated power electronics, a battery management system (BMS), an isolation monitoring device (IMD), one or more safety interlocks, and one or more electrically powered auxiliary systems. The electrically powered auxiliary systems may include, for example, an electric hydraulic pump for steering, an electric compressor, an electric heater, an electric air-conditioning component, an electrically actuated clutch device, and communication interfaces to vehicle networks such as a controller area network (CAN) bus and to vehicle systems such as an anti-lock braking system (ABS). The foregoing embodiments are illustrative and may be combined in various ways.

### BRIEF DESCRIPTION OF THE DRAWINGS

FIG. 1 illustrates a transfer case of a hybrid vehicle system, in some aspects;

FIG. 2 illustrates a rear perspective view of a transfer case of a hybrid vehicle system installed in a vehicle, in some aspects;

FIG. 3 illustrates a front perspective view of a transfer case coupled to an electric motor of a hybrid vehicle system installed in a vehicle, in some aspects;

FIG. 4 illustrates a perspective view of a cooling system of a hybrid vehicle system, in some aspects;

FIG. 5 illustrates a detailed perspective view of an electric motor of a hybrid vehicle system, in some aspects;

FIG. 6 illustrates a flow chart of a method of use of a hybrid vehicle system, in some aspects;

FIG. 7 illustrates a block diagram of a hybrid vehicle system, in some aspects; and

FIG. 8 illustrates a block diagram of a hybrid vehicle system, in some aspects.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

Generally, in some embodiments, a hybrid vehicle system is configured for use with a vehicle that originally employs an internal combustion engine (ICE) and a transfer-case-based driveline. The hybrid vehicle system may be incorporated into a new vehicle platform or adapted for installation into an existing vehicle platform. Broadly, the hybrid vehicle system may include a transfer case, an electric motor, one or more batteries, one or more controllers, and associated mechanical, electrical, and thermal management components that cooperate to selectively exchange energy between the ICE driveline and an electrical energy storage system (e.g., batteries). In some embodiments, the hybrid vehicle system permits the electric motor to function selectively as a generator during operation of the ICE and selectively as a traction motor for providing torque to the driveline through the transfer case.

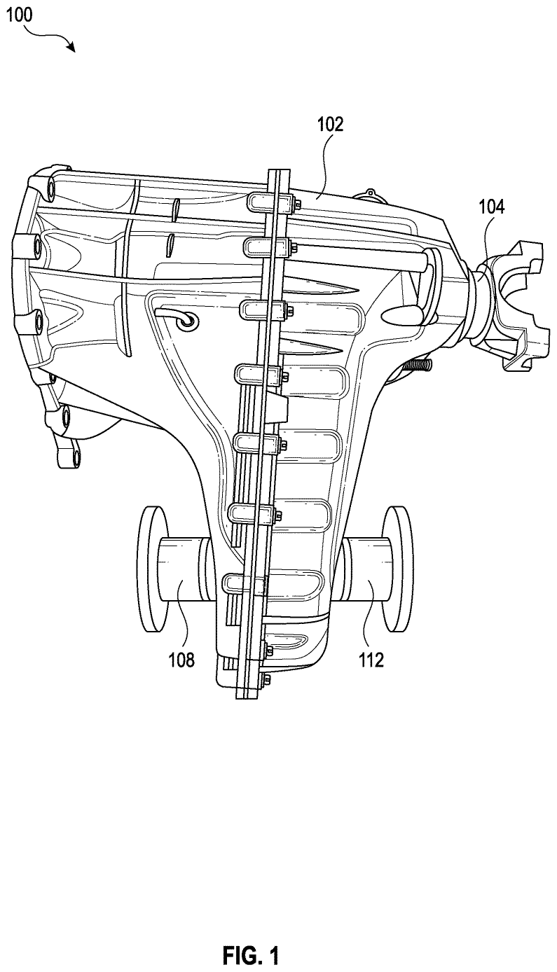

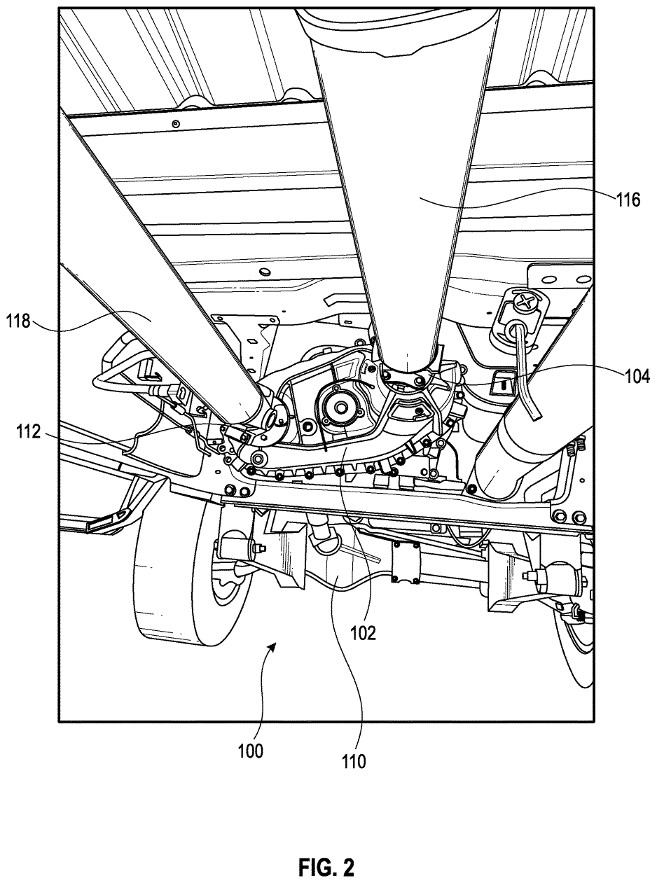

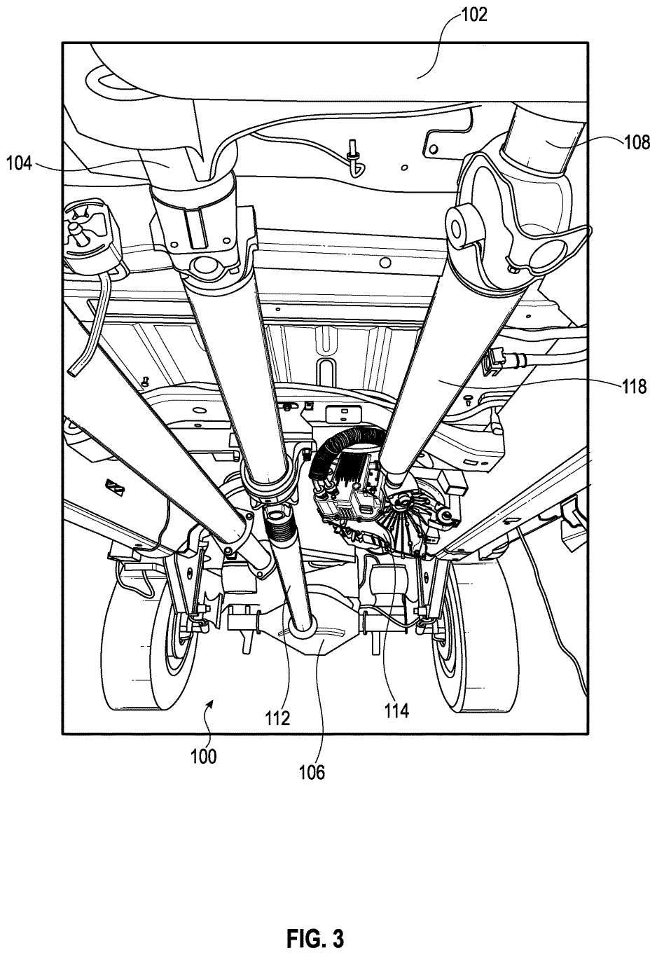

Referring now to FIGS. 1-3, the hybrid vehicle system 100 may include a transfer case 102 having a first output 104, a second output 108, and a third output 112, which may each have a yoke associated therewith. In the illustrated embodiment, the first output 104 is associated with a rear driveline, such as rear differential 106, and the second output 108 is associated with a front driveline, such as front differential 110. The third output 112 is associated with the electric motor 114 and may receive torque from, or deliver torque to, the electric motor 114 through an electric motor shaft 118 or other torque-transmitting member. In some embodiments, a rear output shaft 116 is coupled to the first output 104. Although the drawings depict one representative arrangement, the relative positions of the outputs, shafts, and associated gearing may vary according to vehicle packaging requirements, transfer case design, desired gear reduction, and the intended installation environment. Likewise, the electric motor 114 may be coupled directly to the third output 112 or indirectly through a gearbox, reduction gearset, coupling assembly, clutch, chain, belt, universal joint, constant-velocity joint, or other mechanical interface. While referenced as a third “output,” the above makes clear that it may also function as an input when receiving torque from the electric motor 114.

Because the electric motor 114 is coupled to the transfer case 102, the electric motor 114 may remain in continuous driving communication with the driveline in some embodiments, although selective engagement embodiments are also contemplated. When the vehicle is driven by the ICE, rotational energy present in the transfer case 102 may be conveyed through the third output 112 and the electric motor shaft 118 to the electric motor 114 so that the electric motor 114 operates in a generator mode. Electrical energy produced by the electric motor 114 in generator mode may be conditioned by a motor controller or inverter and supplied to charge one or more batteries. When the one or more batteries satisfy a selected state-of-charge threshold and other operating conditions permit, the direction of energy flow may be reversed so that the electric motor 114 operates in a propulsion mode. In that condition, torque from the electric motor 114 is transmitted through the electric motor shaft 118 to the third output 112 and through the transfer case 102 to a selected driveline output. In some embodiments, the selected driveline output is the front differential 110, thereby enabling electric-only movement of the vehicle at least under certain conditions, or supplemental electric assist while the ICE is operating. In other embodiments, the transfer case 102 may distribute torque to the rear differential 106, to both front and rear driveline components, or according to a commanded transfer-case state.

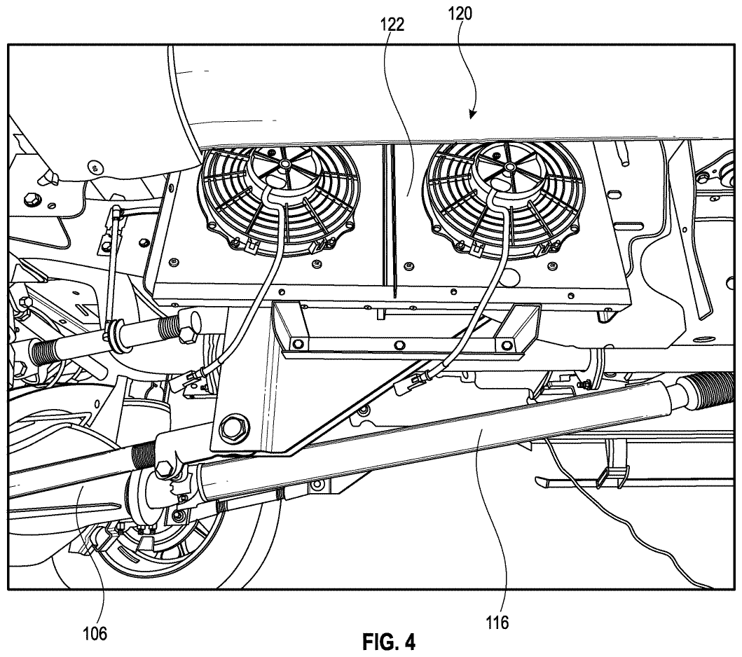

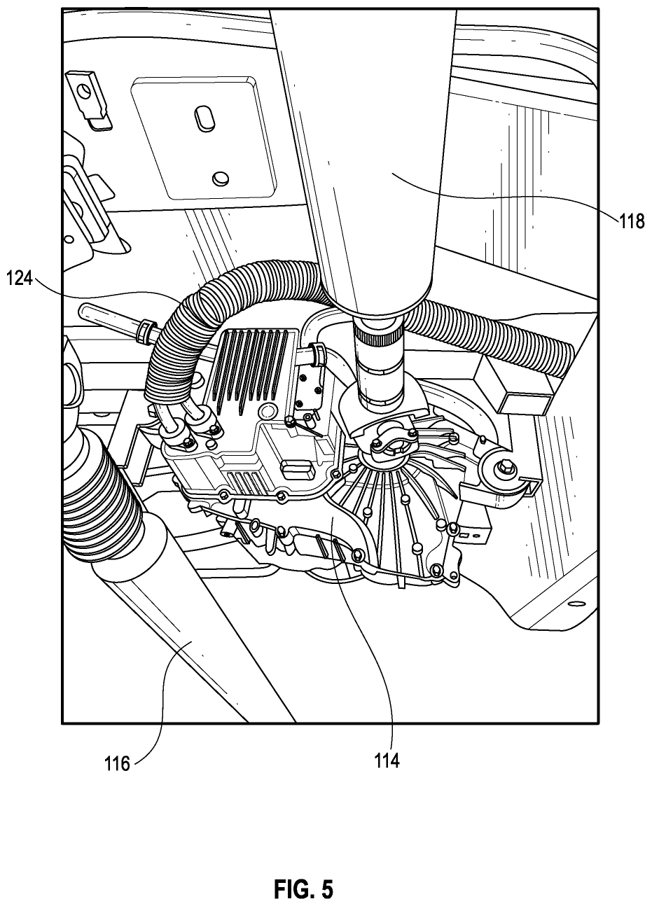

As shown in FIGS. 4-5, in some embodiments the hybrid vehicle system 100 further comprises a cooling system 120 configured to remove heat from the electric motor 114 and, in some embodiments, from associated power electronics, cabling, or other components. The cooling system 120 may include one or more radiators 122, one or more conduits, one or more pumps, one or more heat exchangers, reservoirs, fans, thermostatic valves, and temperature sensors. In some embodiments, a liquid cooling circuit circulates coolant through passages associated with the electric motor 114. In other embodiments, air cooling, mixed liquid-and-air cooling, or a shared thermal management loop may be used. Cooling operation may be controlled in response to motor load, generator load, ambient temperature, battery temperature, inverter temperature, vehicle speed, or other thermal criteria. As shown in FIG. 5, the electric motor 114 may receive power via one or more high voltage cables 124.

In vehicles having a manual transmission, an electronic control module or unit (ECM/U) of the hybrid vehicle system 100 may be configured to coordinate operation of the electric motor 114 with clutch engagement and disengagement. For example, the ECM/U may receive or determine signals corresponding to clutch pedal position, transmission gear selection, engine speed, vehicle speed, and requested torque, and may use such information to determine whether the ICE should remain on, be started, be stopped, or be disconnected from the driveline. In some embodiments, the ECM/U may further command an electrically actuated clutch device or provide prompts or interlocks associated with clutch operation. Such control may improve drivability during transitions between ICE propulsion, electric propulsion, blended propulsion, and charging modes.

In vehicles having an automatic transmission, the ECM/U may be configured to coordinate operation of the electric motor 114 with torque converter state, transmission gear selection, shift timing, and engine start-stop events. In some embodiments, the ECM/U may communicate with one or more existing vehicle controllers over a vehicle network to request or command transmission states that support efficient generator operation, electric assist, or electric-only propulsion. By way of example, the ECM/U may inhibit or request selected gear changes, adjust converter lockup strategy, or alter torque requests during transitions so as to reduce driveline shock and maintain desired vehicle responsiveness. Similar strategies may be used with automated manual transmissions, dual-clutch transmissions, continuously variable transmissions, or other driveline architectures.

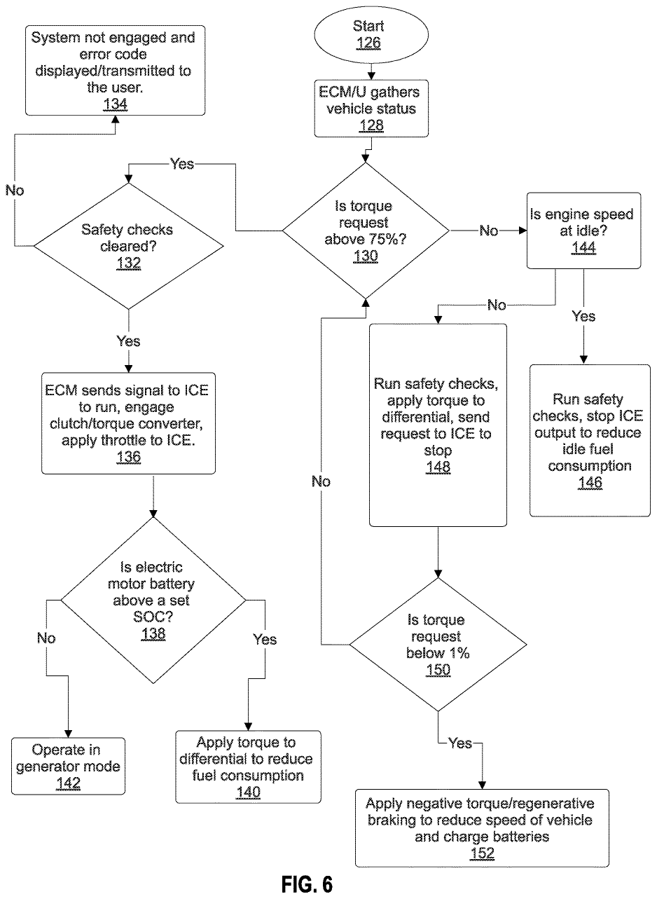

Referring to FIG. 6, in some methods of operation, the system 100 starts at 126 and the ECM/U, at 128, first reads or receives status information for the vehicle and various hybrid-system components. Such information may include accelerator position, brake input, torque request, motor speed, transfer case state, battery state of charge, battery health, temperatures, fault states, and wheel-speed information. The ECM/U may then determine, at step 130, whether a requested torque level exceeds a selected threshold (e.g., 75%, although other thresholds may be set). If the requested torque level exceeds the threshold, but the safety checks are not cleared at step 132, the system reports an error at 134. If safety checks are satisfied at step 132, the ECM/U may command the ICE, at step 136, to operate and may engage or maintain engagement of a clutch, torque converter, or other driveline coupling. At step 138, if battery conditions permit (e.g., battery above a predetermined state-of-charge), the electric motor 114 may additionally apply positive torque through the transfer case 102 to the front differential 110 to reduce fuel consumption, increase total available wheel torque, or support transient acceleration at step 140. If battery state of charge is below a selected threshold at step 138, the ECM/U may instead command the electric motor 114 to operate in a generator mode so that at least a portion of driveline energy is converted into stored electrical energy.

Returning to step 130, if the requested torque level is less than a selected threshold and the ICE is at idle speed in step 144, the system 100 verifies safety checks are satisfied and then the ECM/U may reduce ICE output, disengage a clutch or torque converter as appropriate, stop the ICE at step 146. If the ICE is not at idle in step 144, the system 100 may run safety checks and then apply torque to the front differential or otherwise prioritize electric propulsion at step 148. In such a condition, the electric motor 114 may apply positive torque through the transfer case 102 to the front differential 110 to propel the vehicle. If the torque request is very low (e.g., 1% or less (although other percentages may be used)), such as at step 150, if braking is requested, or if deceleration is desired, the ECM/U may command, at step 152, negative torque from the electric motor 114 so that the electric motor 114 provides regenerative braking while charging the one or more batteries. The particular threshold values used for entry into ICE mode, blended mode, electric-only mode, or regeneration mode may be predetermined, adaptive, user-selectable, map-based, or determined according to operating conditions. The control strategy may also limit or disable electric propulsion or regeneration during fault conditions, over-temperature conditions, low-traction conditions, or other protected states.

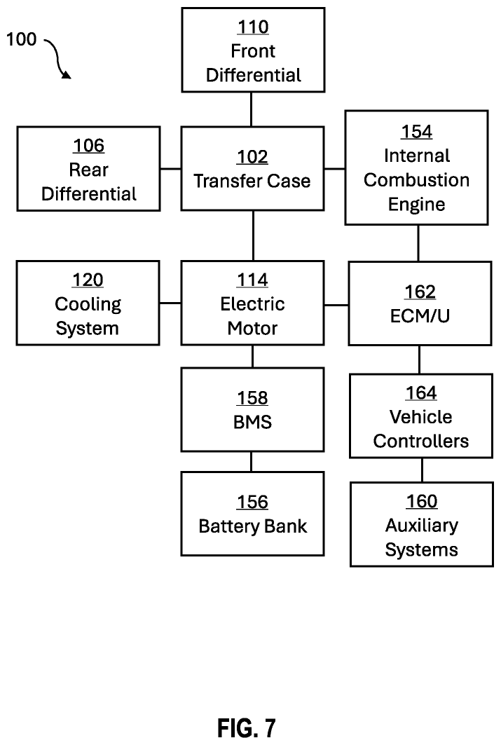

As shown in FIG. 7, in some embodiments, the hybrid vehicle system 100 coupled to an ICE 154 comprises an electric motor 114, a battery bank 156 (e.g., one or more batteries), a battery management system (BMS) 158, an isolation monitoring device (IMD), one or more contactors, fuses, service disconnects, hood or enclosure safety switches, and one or more electrically powered auxiliary systems 160. The auxiliary systems may include, for example, an electric hydraulic pump for steering, an electric air compressor, an electric heater, an electric air-conditioning component, and one or more electrically actuated clutch or pump devices. In some embodiments, the hybrid vehicle system 100 communicates with existing vehicle systems via the ECM/U 162 or other vehicle controllers 164, such as an anti-lock braking system (ABS), traction-control system, stability-control system, and a controller area network (CAN) bus or other vehicle communication network. Such communication may be used to coordinate regenerative braking, fault handling, torque blending, diagnostics, and operator notifications. Additional sensors, relays, high-voltage interlocks, shielding, and enclosure features may be included as desired for safety, serviceability, and compliance.

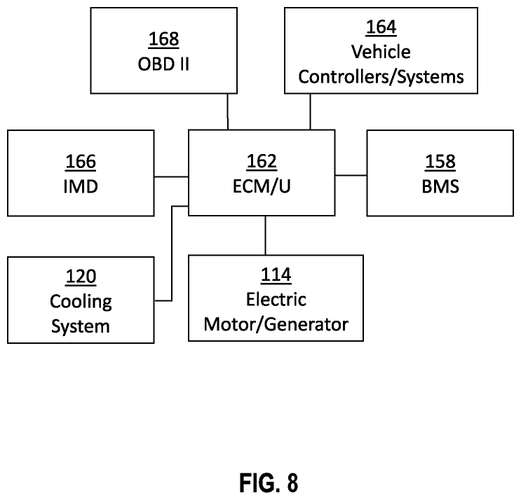

FIG. 8 illustrates a block diagram wherein the ECM/U 162 of the hybrid vehicle system 100 is configured to monitor the status of the vehicle components/systems 164, the IMD 166, BMS 158, and the electric motor 114. Based upon the status of one or more components, as outlined earlier herein, the ECM/U 162 is configured to command the vehicle components/systems 164, the IMD 166, BMS 158, and the electric motor 114. As shown, the cooling system 120 may likewise be monitored and controlled via the ECM/U 162, with a user being able to program or otherwise control the ECM/U through an OBD II port 168.

Accordingly, in some embodiments, the hybrid vehicle system 100 addresses the needs identified above by providing an electric motor 114 that is operably coupled to the transfer case 102 so that the electric motor 114 may selectively recover mechanical energy from an operating ICE driveline, charge one or more batteries without relying exclusively on wheel-end regenerative braking, and return stored electrical energy to the driveline for traction assist or electric propulsion. By coupling the electric motor 114 into the transfer-case-based architecture, the hybrid vehicle system 100 may provide a compact and adaptable arrangement for vehicles having front and rear differential outputs, while reducing or avoiding the need for complete redesign of the base vehicle transmission architecture. In this manner, the disclosed system may improve overall efficiency, support reduced fuel consumption and emissions under selected operating conditions, and facilitate integration of hybrid functionality into existing or newly manufactured vehicle platforms.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A hybrid vehicle system for a vehicle having an internal combustion engine, the hybrid vehicle system comprising:
a transfer case comprising a first output associated with a rear driveline, a second output associated with a front driveline, and a third output associated with an electric motor;
the electric motor coupled to the third output of the transfer case such that the electric motor is configured to selectively operate in a generator mode and in a propulsion mode;
one or more batteries electrically coupled to the electric motor; and
a controller configured to cause the electric motor to operate in the generator mode to charge the one or more batteries when rotational energy is received from the internal combustion engine through the transfer case, and to cause the electric motor to operate in the propulsion mode to transmit torque through the transfer case to the front driveline.

2. The hybrid vehicle system of claim 1, wherein the electric motor is coupled to the third output by a motor shaft.

3. The hybrid vehicle system of claim 1, wherein the controller is configured to cause the electric motor to operate in the propulsion mode when the one or more batteries satisfy a selected state-of-charge threshold.

4. The hybrid vehicle system of claim 1, wherein the controller is configured to cause the electric motor to transmit torque through the transfer case to a front differential associated with the front driveline.

5. The hybrid vehicle system of claim 1, further comprising a motor controller or inverter electrically coupled between the electric motor and the one or more batteries.

6. The hybrid vehicle system of claim 1, further comprising a cooling system configured to remove heat from the electric motor.

7. The hybrid vehicle system of claim 1, wherein the controller is configured to coordinate operation of the electric motor with at least one of a clutch, a torque converter, or a transmission gear selection.

8. A hybrid vehicle system for a vehicle having an internal combustion engine, the hybrid vehicle system comprising:
a transfer case coupled to a transmission of the vehicle, the transfer case comprising a first output associated with a rear driveline, a second output associated with a front driveline, and a third output;
an electric motor mechanically coupled to the third output of the transfer case;
a battery bank electrically coupled to the electric motor; and
an electronic control module configured to selectively cause the electric motor to (i) receive mechanical energy through the transfer case and generate electrical energy for storage in the battery bank, and (ii) receive electrical energy from the battery bank and provide propulsion torque through the transfer case.

9. The hybrid vehicle system of claim 8, wherein the propulsion torque is delivered to the front driveline through the second output of the transfer case.

10. The hybrid vehicle system of claim 8, wherein the electronic control module is configured to cause the electric motor to generate electrical energy when a state of charge of the battery bank is below a selected threshold.

11. The hybrid vehicle system of claim 8, wherein the electronic control module is configured to cause the electric motor to provide supplemental positive torque when a requested torque level exceeds a selected threshold and a state of charge of the battery bank is above a predetermined threshold.

12. The hybrid vehicle system of claim 8, wherein the electronic control module is configured to cause the electric motor to provide regenerative braking by applying negative torque through the transfer case to a front differential during deceleration.

13. The hybrid vehicle system of claim 8, further comprising a battery management system and an isolation monitoring device associated with the battery bank.

14. The hybrid vehicle system of claim 8, wherein the electronic control module is configured to communicate with at least one of an anti-lock braking system, a traction-control system, a stability-control system, or a controller area network bus.

15. A method of operating a hybrid vehicle system of a vehicle having an internal combustion engine, a transfer case, an electric motor coupled to the transfer case, and one or more batteries, the method comprising:
receiving, by a controller, vehicle status information;
determining, by the controller, a requested torque level based on the vehicle status information;
causing the electric motor to operate in a generator mode to charge the one or more batteries when rotational energy is available through the transfer case; and
causing the electric motor to operate in a propulsion mode to provide torque through the transfer case when the one or more batteries are above a predetermined threshold.

16. The method of claim 15, further comprising causing the electric motor to provide torque through the transfer case to a front differential.

17. The method of claim 15, further comprising causing the electric motor to provide supplemental positive torque when the requested torque level exceeds a selected threshold.

18. The method of claim 15, further comprising causing the electric motor to provide regenerative braking by applying negative torque through the transfer case to a front differential during deceleration.

19. The method of claim 15, further comprising causing the internal combustion engine to be reduced in output or stopped when the requested torque level is below a selected threshold and safety checks are satisfied.

20. The method of claim 15, further comprising limiting or disabling electric propulsion or regeneration during a fault condition, an over-temperature condition, or a low-traction condition.
